(19) United States
(12) Patent Application Publication
(10) Pub. No.: US 2004/0049452 A1
(43) Pub. Date: Mar. 11, 2004

(54) Multiple credit line presentation instrument

(75) Inventor: Lynn Holm Blagg, Omaha, NE (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Greenwood Village, CO

(21) Appl. No.: 10/237,572

(22) Filed: Sep. 9, 2002

(51) Int. Cl. G06F 17/60

(52) U.S. Cl. 705/39

(57) ABSTRACT

The present invention provides systems and methods for consummating transactions realized using credit cards and other types of presentation instruments. The methods can include, inter alia, identifying a presentation instrument associated with a transaction request. Such a presentation instrument is associated with at least two underlying accounts, and it is determined the proportion in which to apply the amount of the transaction request to the underlying accounts. The systems can include various hardware and software used to implement this and other methods.

### CROSS-REFERENCES TO RELATED APPLICATIONS

The present application is related to U.S. patent application No. 09/298,417, entitled “Methods For Processing a Group of Accounts Corresponding to Different Products”, filed on Apr. 23, 1999, sharing a common inventor with and assigned to the assignee of the present invention; U.S. patent application Ser. No. 09/298,505, entitled “Method For Linking Accounts Corresponding to Different Products”, filed on Apr. 23, 1999, sharing a common inventor with and assigned to the assignee of the present invention; U.S. patent application Ser. No. 09/298,521, entitled “Method For Defining a Relationship Between an Account and a Group”, filed on Apr. 23, 1999, sharing a common inventor with and assigned to the assignee of the present invention; U.S. patent application Ser. No. ______ (Attorney Docket Number 20375-022400US), entitled “Systems And Methods For Accessing And Modifying Usage Parameters Associated With a Financial Transaction Account”, filed on Jun. 13, 2002, sharing a common inventor with and assigned to the assignee of the present invention; and U.S. patent application Ser. No. ______ (Attorney Docket Number 20375-022300US), entitled “Systems And Methods For Non-Account Based Liability Reporting”, filed on ______, 2002, and also sharing a common inventor with and assigned to the assignee of the present invention. Each of the aforementioned patent applications in their entirety are incorporated herein by reference for all purposes.

### BACKGROUND OF THE INVENTION

The present invention relates generally to the field of financial transaction processing, and in particular to systems and methods for using financial products linked to a plurality of accounts to consummate financial transactions.

Financial products are used for conducting a wide range of consumer and business transactions. As an example, a credit card associated with an underlying account can be issued to an account holder by a bank or other issuer. The account holder utilizes the credit card, and in doing so, incurs liabilities that are applied to the underlying account. At some point later, the account holder is asked to bring the account associated with the credit card current.

In some instances, an account holder may also hold a credit card associated with another account. The credit card is associated with another account to which the account holder incurs liabilities. In such cases, each of the credit cards may provide distinct advantages depending upon the liability incurred. Thus, it can be advantageous for an account holder to use one credit card over the other depending upon the given circumstances. Obtaining such advantages, however, can be complicated and burdensome to the account holder. Thus, for at least the aforementioned reasons, there exists a need in the art for advanced systems and methods that can provide advantages without the existing complications and burden.

### BRIEF SUMMARY OF THE INVENTION

Among other things, the present invention provides systems and methods for performing transactions that utilize presentation instruments associated with a plurality of underlying accounts. As such, various embodiments of the present invention provide systems and methods for associating accounts with presentation instruments, for authorizing such transactions, for processing such transactions, and/or for maximizing or pooling features associated with such transactions and/or accounts. Such features can include, but are not limited to, augmented credit lines, cash back bonuses, immediate discounts, and rewards such as frequent flyer miles or points for hotel rooms.

As just one example of the present invention, a credit card can be associated with a general account and also with an account specific to a merchant. The credit card can be used by an account holder to incur charges or other liabilities at any number of establishments. Systems in accordance with the present invention receive transaction requests generated by using the credit card. The systems and methods of the present invention are then used to determine which of the plurality of underlying accounts to apply the transaction amount. In some cases, application of the transaction amount to one account or another is determined based on a rule set. Further, in some cases, the rule set is tailored to maximize features offered through use of one account or the other. Therefore, in accordance with some embodiments of the present invention, an account holder can obtain the advantages of multiple accounts through use of a single credit card or other presentation instrument.

Particular embodiments of the present invention provide methods for processing transactions realized using presentation instruments. Such methods include identifying a presentation instrument associated with a transaction request including a transaction amount. The presentation instrument is associated with a plurality of accounts. The method further includes determining a portion of the transaction amount to apply to one of the plurality of accounts.

In some instances, the account to which the transaction portion is applied is a closed loop account, and the method further includes identifying the merchant issuer associated with the transaction request, and identifying a match of the merchant issuer and the account, such that determining the portion of the transaction amount to apply to the first account is based at least in part on the identified match. In other instances, the account to which the transaction portion is applied is a general account, and the method further includes identifying the merchant associated with the transaction request, and accessing a database including information associated with a holder of the presentation instrument, wherein the information associated with the holder does not indicate that the presentation instrument is associated with the merchant.

Various instances include identifying both a good and a merchant associated with the transaction request. This information is then used to identify a match of the first account and the merchant that can be used to determine the portion of the transaction amount to apply to one of the plurality of accounts. In some cases, the portion of the transaction amount includes all of the transaction amount, while in other cases, the portion of the transaction amount is only part of the total transaction amount. In some cases, other portions of the transaction amount are applied to different accounts associated with the presentation instrument.

In some cases, the method further includes associating one or more accounts with the presentation instrument, and providing a consolidated statement reflecting at least a portion of the transactions associated with the associated accounts. In yet other cases, the method incudes accessing a rule set associated with the presentation instrument. Such a rule set can be used to determine which account to apply a transaction. In particular cases, the rule set is defined to maximize one or more features associated with one or more of the associated accounts. Further, such rule sets can be defined by a user, an issuer, a processor, or some combination thereof. Indeed, some instances of the methods can include defining the rule set, providing the rule set to a holder of the presentation instrument, and receiving authorization to apply the rule set.

Other embodiments of the present invention provide methods for processing transactions realized using presentation instruments. Such systems can comprise a computer including a processor, a communication device, and a computer readable medium. The communication device is operable to receive transaction requests including a transaction amount, and the computer readable medium includes information about a presentation instrument associated with a plurality of accounts, as well as computer executable instructions. Such instructions can be executable to identify the presentation instrument associated with the transaction request, and determine a portion of the transaction amount to apply to the first account. In some cases, such instructions are further executable by the processor to identify a merchant issuer associated with the transaction request, and match one of the plurality of accounts to the merchant issuer.

Yet another embodiment of the present invention provides methods for consummating transactions realized using presentation instruments. Such methods include associating a closed loop account with a presentation instrument, wherein the presentation instrument is associated with a general account; receiving the presentation instrument in relation to a transaction request, wherein the transaction request includes a transaction amount; and applying the transaction amount to the closed loop account.

In one particular embodiment of a method for processing transactions realized using presentation instruments in accordance with the present invention, a presentation instrument associated with a transaction request is identified. The identified presentation instrument is associated with at least a special purpose general account and another account. The method further includes identifying a characteristic associated with the transaction request that is also related to the special purpose general account. A match is identified between the characteristic and the special purpose general account, and the transaction request is approved or authorized in accordance with authorization procedures associated with the special purpose general account. In some cases, the characteristic can be a class of goods, a transaction amount, and/or a merchant.

In yet another embodiment of the present invention, a method for processing transactions realized using presentation instruments in accordance with the present invention is provided. In the embodiment, a presentation instrument associated with a transaction request is identified. The identified presentation instrument is associated with at least a home equity line and another account. The method further includes identifying as part of the transaction request, a home improvement product chargeable to the home equity line. A match is identified of the home improvement products and the home equity line, and it is determined to apply at least a portion of the transaction amount to the home equity line based at least in part on the identified match.

Yet other embodiments of the present invention include methods for consummating transactions realized using presentation instruments. Such methods can include associating a closed loop account with a presentation instrument, where the presentation instrument is also associated with a general account. The presentation instrument is received in relation to a transaction request that includes a transaction amount. The transaction request is then applied to the closed loop account.

Yet a further embodiment of the present invention provides a system for linking a plurality of presentation instruments to a plurality of accounts. The system includes a computer readable medium with a first record associating a first presentation instrument with a first and a second account, and a second presentation instrument with a third and a fourth account. In some instances, the first account is a default account to the first presentation instrument, and the third account is a default account to the second presentation instrument. In particular instances, the second account and the fourth account are the same account.

Further embodiments include methods for processing transactions realized using a presentation instrument. Such methods can include identifying a presentation instrument associated with a transaction request, where the transaction request includes a transaction amount, and where the presentation instrument is associated with at least a first account and a second account. The first account is selected to receive the transaction request, and one of the first account and the second account is selected to receive the transaction request as posted. In some instances, the transaction request as authorized is different from the transaction request as posted. In various instances, the second account is selected to receive the transaction request as posted, and the transaction request as posted is re-authorized. Some instances further include generating an exception report indicating the difference between the transaction as authorized and the transaction as posted. Further, some instances where selecting one of the first account and the second involves selected the first account can include: selecting the second account to receive the transaction request as posted; re-authorizing the transaction request, wherein the transaction request as re-authorized is the same as the transaction request as posted; and transferring the transaction request as posted from the first account to the second account.

The preceding summary provides only a general outline of the embodiments according to the present invention. Many other objects, features and advantages of the present invention will become more fully apparent from the following detailed description, the appended claims and the accompanying drawings.

### BRIEF DESCRIPTION OF THE DRAWINGS

A further understanding of the nature and advantages of the present invention may be realized by reference to the figures which are described in remaining portions of the specification. In the figures, like reference numerals are used throughout several figures to refer to similar components. In some instances, a sub-label consisting of a lower case letter is associated with a reference numeral to denote one of multiple similar components. When reference is made to a reference numeral without specification to an existing sub-label, it is intended to refer to all such multiple similar components.

FIG. 1 is a block diagram of a transaction processing system in accordance with some embodiments of the present invention;

FIG. 2 illustrates a computer used by a transaction processor to perform various functions in accordance with the present invention;

FIG. 3 is an organizational diagram illustrating an exemplary database implemented in accordance with embodiments of the present invention;

FIG. 4 is a flow diagram illustrating a method in accordance with one embodiment of the present invention for associating accounts with one or more presentation instruments;

FIG. 5 is a flow diagram illustrating a method in accordance with an embodiment of the present invention for authorizing transactions;

FIG. 6 is a flow diagram illustrating a method in accordance with some embodiments of the present invention for processing transactions;

FIG. 7 is a flow diagram illustrating another method in accordance with an embodiment of the present invention for authorizing and/or splitting transactions;

FIG. 8 is a flow diagram illustrating a method in accordance with some embodiments of the present invention for maximizing features associated with various presentation instruments; and

FIG. 9 illustrates an exemplary embodiment of a website offering access to information associated with a presentation instrument.

### DETAILED DESCRIPTION OF THE INVENTION

Among other things, the present invention provides systems and methods for performing transactions that utilize presentation instruments associated with a plurality of underlying accounts. As such, various embodiments of the present invention provide systems and methods for associating accounts with presentation instruments, for authorizing such transactions, for processing such transactions, and/or for maximizing or pooling features associated with such transactions. Such features can include frequent flyer miles, points for hotel rooms, cash back bonuses, immediate discounts, augmented credit lines, and the like.

As just one example of the present invention, a credit card can be associated with a general account and also with an account specific to a merchant. The credit card can be used by an account holder to incur charges or other liabilities at any number of establishments. Systems in accordance with the present invention receive transaction requests generated by using the credit card. The systems and methods of the present invention are then used to determine which of the plurality of underlying accounts to apply the transaction amount. In some cases, application of the transaction amount to one account or another is determined based on a rule set. Further, in some cases, the rule set is tailored to maximize features offered through use of one account or the other. As will be appreciated, the term “transaction request” as used herein includes any request to authorize and/or post a transaction.

As used herein, a “presentation instrument” can be any instrument and/or information used by an account holder to effectuate a financial transaction. Thus, for example, a presentation instrument can be a credit card, a debit card, a smart card, an account number, a personal identification number, a key fob, automobile fob, other hardware device with builtin security authentication mechanisms, and/or any combination thereof. Such presentation instruments can be associated with a product offered by an issuer of the presentation instrument, or by some other issuer. Thus, for example, a presentation instrument may be associated with a MASTERCARD or VISA product. Alternatively, the presentation instrument may be associated with a credit card product and a stored value redemption card.

From the previous discussion, it will be appreciated that as used herein an “account holder” can be any individual or entity having access to a presentation instrument, and/or accounts associated therewith. Further, it will be appreciated that an “issuer” can be any entity that maintains accounts that are associated with one or more presentation instruments. Thus, for example, issuers can include a bank, a credit card company, a retailer, and the like. In some cases, an issuer also provides presentation instruments associated with the accounts, while in other cases, an issuer only maintains accounts accessed via such presentation instruments.

Such accounts can be distinguished as “general accounts” and “closed loop accounts.” Where “account” is used without being designated either a general or closed loop account, it should be interpreted to be either type of account, unless it is clear from the surrounding discussion that it can only be one or the other. As used herein, a general account is an account to which liabilities from a number of merchants can be accrued. Thus, for example, a credit card issued by a bank is considered a general account. Based on the disclosure provided herein, one of ordinary skill in the art will recognize many other types of general accounts including, for example, a debit account with a bank, a checking account with a bank, a savings account with a bank, a charge account with a credit card company, a stored value card account, and the like. Yet another example of a general account is an account to which rewards from other accounts are posted, and which is generally accessible as a stored value general account. As yet another example, an account can be a fixed payment account, such as a closed end loan. As will be recognized by one of ordinary skill in the art, such closed end loans can include a car loan.

Two or more types of general accounts are possible in accordance with the present invention. For example, one type of general account is a general purpose general account that treats all purchases equally. Another type of general account is a special purpose general account that is useful in relation to any number of merchants, but which provides some additional benefit or feature when used in relation to a particular class of goods, or a particular merchant or group of merchants. Such special purpose general accounts may, for example, provide frequent flyer rewards for all purchases, but double the amount of any such reward for travel purchases. Alternatively, such accounts may feature one interest rate for most purchases, but offer a lower interest rate for purchases of big ticket items that maintain some level of long term value capable of satisfying a later repossession in the case of default. Other examples may include offering cash back rewards for use of such a card at one retailer, but not at other retailers. Yet another example can include an account useful for purchasing any goods, but offering cash back on the purchase of gasoline from a particular retailer. Another special purpose general account may offer an extension of credit for the purchase of big ticket items. Of course, based on the disclosure provided herein, one of ordinary skill in the art will recognize a variety of general accounts and types thereof.

Alternatively, as used herein, a closed loop account is an account limited to accepting liabilities from a particular retailer or group of retailers, and/or for accepting liabilities related to a limited class of goods. Thus, settlement of a purchase transaction in a closed loop account is handled within a single entity, or a closed network of enities. Thus, for example, a closed loop account can be a merchant account useful for making purchases with one merchant. Other examples include a stored value account associated with gift certificate to a mall, and a home equity account limited to the purchase of home improvement products. In some instances, such closed loop accounts are useful in relation to a particular retailer which also performs settlement functions in relation to such accounts. Based on the disclosure provided herein, one of ordinary skill in the art will recognize many other types of closed loop accounts.

Further, it will be recognized that presentation instruments can be used to purchase goods, services, and/or any combination thereof. For convenience, the term “good” is used herein to describe such goods, services, and combinations thereof. Thus, whenever the term good is encountered, it should be interpreted as encompassing the entire universe of goods and/or services unless it is otherwise clear from the description that the specific use of the term good is limited to only goods as commonly known in the industry.

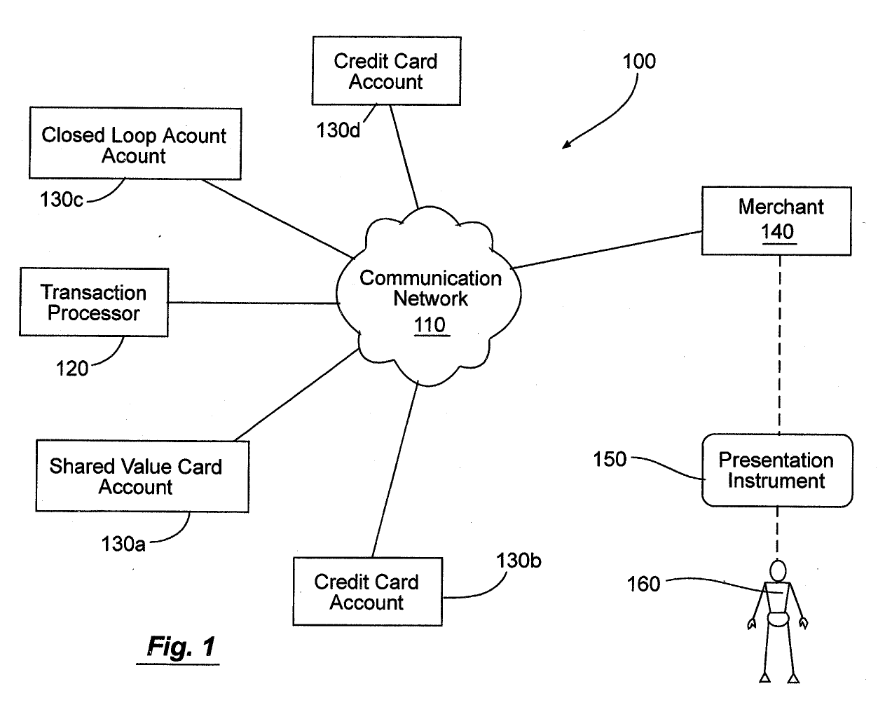

Referring to FIG. 1, a block diagram of a processing system 100 in accordance with some embodiments of the present invention is illustrated. Processing system 100 includes a transaction processor 120 that can access a plurality of accounts 130, and a merchant 140 each in communication via a communication network 110. Further, a presentation instrument 150 is shown being presented to merchant 140 by an account holder 160. In the particular embodiment, account holder 160 is associated with each of accounts 130. Such accounts include a stored value card account 130a, a credit card account 130b, a closed loop account 130c, and another credit card account 130d. As illustrated, a transaction request processed by transaction processor 120 can be approved, and an amount associated with the transaction request can be applied to any of the accounts 130 according to one or more rules as further discussed below. Based on the description provided herein, one of ordinary skill in the art will recognize many other account types and combinations thereof that can be used in relation to the present invention. Further, one of ordinary skill in the art will recognize many other entities that can maintain such accounts and combinations thereof.

Processing of the transaction request can include communication between transaction processor 120, merchant 140, and one or more entities maintaining accounts 130. In one case, accounts 130 are maintained by transaction processor 130. Such communication is accomplished by communication network 110 that can be a single communication medium or a combination of communication media. Thus, communication network 110 can be any communication network capable of providing communications between the various entities of processing system 100. In some embodiments, communication network 110 is the Internet providing message based communication between transaction processor 120 any of the entities maintaining accounts 130, and merchant 140. In other embodiments, communication network 110 comprises a TCP/IP compliant virtual private network (VPN). In yet other embodiments, communication network 110 includes the Internet for communication between merchant 160 and transaction processor 120, and a VPN for facilitating communications between transaction processor 120 and entities maintaining accounts 130. However, it should be recognized that other communication networks could be used to provide similar functionality. For example, communication network 110 can be a local area network (LAN), a wide area network (WAN), a telephone network, a cellular telephone network, a virtual private network (VPN), the Internet, an optical network, a wireless network, or any other similar communication network or combination thereof.

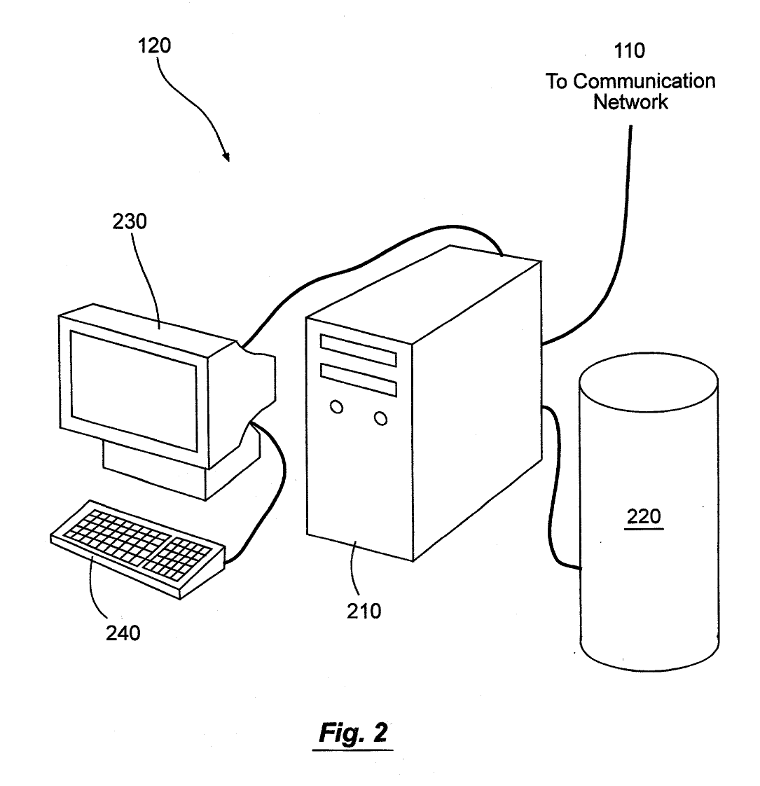

Turning to FIG. 2, an embodiment of transaction processor 120 is illustrated. As illustrated, transaction processor 120 includes at least one computer 210 with an associated monitor 230 and input device 240. Computer 210 can be any microprocessor based device, digital signal processor based device, or combination of such devices capable of performing the functions discussed below in relation to transaction processor 120. In one particular embodiment, computer 210 is a mainframe computer, while in other embodiments, computer 210 is a personal computer (“PC”), a network server, and/or a cluster of PCs and/or network servers.

Further, computer 210 includes a communication device (not shown) that allows computer 210 to communicate via communication network 110. Such a communication device can be any device or combination of devices capable of interfacing to communication network 110, such as, an internal modem, an external modem, an Ethernet card, or the like. In addition, computer 210 includes various forms of memory such as random access memory (RAM), and disk memory such as a hard disk drive. Such memory provides a computer readable medium that includes computer executable instructions that are executed by a processor of computer 210 to perform the various functions associated with transaction processor 120. Based on the discussion provided herein, one of ordinary skill in the art will recognize many other types of computers, communication devices, and/or computer readable media capable of performing functions in relation to the present invention.

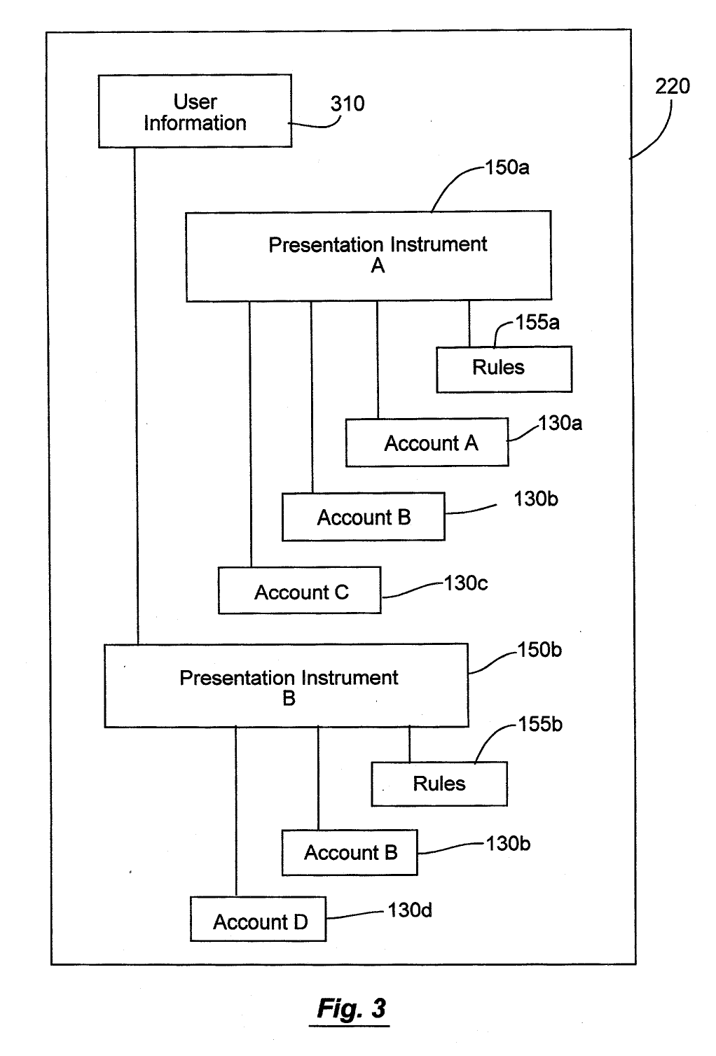

As illustrated, computer 210 is communicably coupled to a database 220. Database 220 can be integral to computer 210, or external to computer 210. In one particular embodiment, database 220 is an ORACLE relational database, while in other embodiments database 220 is a custom database. FIG. 3 is an organizational diagram illustrating an embodiment of database 220 including information associated with and/or about various presentation instruments 150, accounts 130, and account holders 160. According to the embodiment, database 220 is organized in relation to one or more account holders 160. Thus, account holder information 310 associates the various presentation instruments 150a, 150b associated with the account holder, and the various accounts 130a, 130b, 130c, 130d that are accessible via respective presentation instruments 150a, 150b. Further, rule sets 155a, 155b are associated with respective presentation instruments 150a, 150b. As detailed below, rule sets 155a, 155b provide guidance in determining which account(s) 130 to apply transaction amounts incurred in relation to presentation instruments 150. It should be noted that rule sets can be associated with both user information 310 and an issuers information (not shown). Thus, rule sets can be implemented by users, by issuers, and in relation to particular presentation instruments. Further, such rule sets can be a combination of rules governed by a user, issuer, and/or any other entity involved. Based on the disclosure provided herein, one of ordinary skill in the art will recognize many other organizations that are possible in accordance with the present invention.

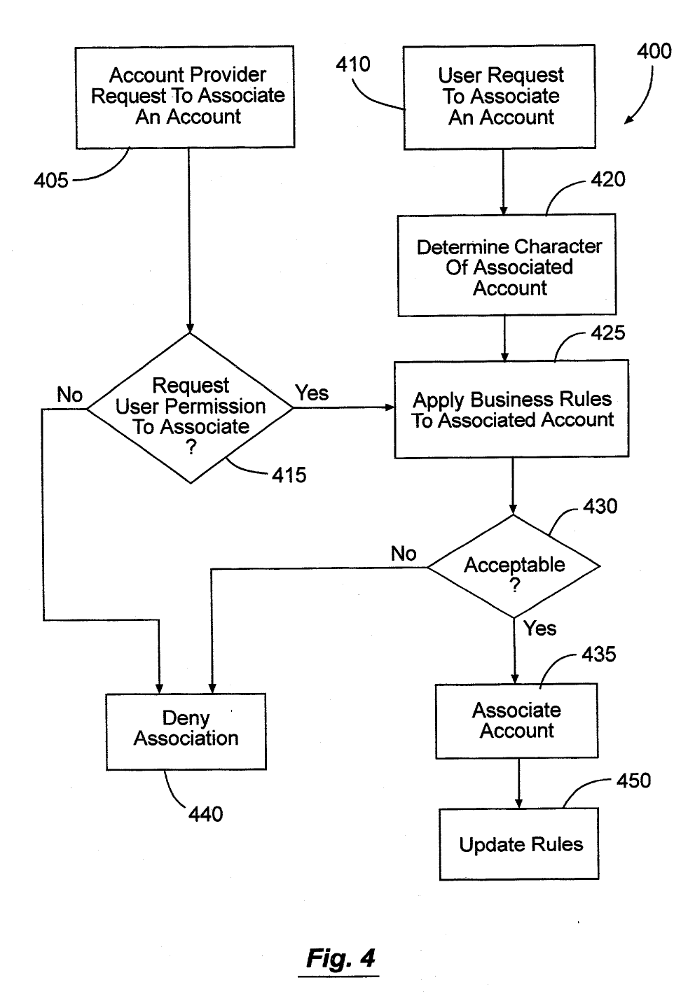

The use of processing system 100 is discussed in relation to FIGS. 4 through 8. Referring to FIG. 4, a flow diagram 400 illustrating a method in accordance with some embodiments of the present invention for associating one or more accounts with a presentation instrument is illustrated. Following flow diagram 400, a request is received to associate an account with a presentation instrument (blocks 405, 410). In some instances, such a request is received from a bank or other entity that provides and/or maintains the account to be associated with the presentation instrument (block 405). In other instances, such a request is received from an account holder owning the account that is to be associated with the presentation instrument (block 410).

A request from an entity maintaining the account to be associated (block 405) identifies one or more of a presentation instrument 150, and an account holder to transaction processor 120. Where the request identifies an account holder, the account holder is contacted to request permission to associate the new account with an existing presentation instrument held by the account holder (block 415). Alternatively, where the request does not identify the account holder, but rather identifies a presentation instrument, transaction processor 120 matches the identified presentation instrument with the account holder, and as previously discussed, requests permission from the account holder to associate the new account with the presentation instrument (block 415). Where the account holder does not give permission to associate the new account with the presentation instrument, the attempted association is terminated (block 440). Alternatively, where the request to associate the account is accepted, further processing related to associating the account is performed as detailed below.

Such a process of allowing an entity maintaining accounts to request that an account be associated with a presentation instrument can be advantageous for a number of reasons. For example, among other advantages, it provides alternative avenues for marketing financial products to consumers, and it provides a quick and convenient mechanism for extending credit to a consumer without requiring issuance of additional presentation instruments. Further, methods and systems in accordance with the present invention facilitate interaction with credit card companies seeking partnerships with retailers, and a retailer's desire to provide broader financial product offerings. Various advantages are appreciated through analysis of an exemplary transaction scenario.

In the exemplary scenario, account holder 160 provides presentation instrument 150 to merchant 140 to consummate a transaction. A clerk representing merchant 140 asks account holder 160 if they would like to open an account specific to merchant 140 through which account holder would be eligible for various incentives. Often such an invitation is rejected because it would require that account holder 160 receive and maintain yet another presentation instrument 150. However, in accordance with the present invention, account holder 160 could still be offered an account specific to merchant 140 from which account holder 160 could benefit, without requiring the issuance of an additional presentation instrument. Rather, merchant 140 could create a merchant specific account for account holder 160, and request that transaction processor 120 associate the merchant specific account with presentation instrument 150 and/or account holder 160. Such an association would then allow various transaction amounts incurred through use of presentation instrument 150 to be applied to the merchant specific account. The rules and procedures for determining which account to apply a transaction amount to are discussed in more detail below.

As yet another avenue of marketing financial products to account holders, an entity supplying a financial product can market the products to transaction processor 120. Transaction processor 120 could identify various account holders to which the products may be of interest, and request permission from such account holders to allow the entity marketing the financial product to create an account for the account holder, and for permission to allow transaction processor 120 to associated the newly created account with an existing presentation instrument 150 held by the account holder. Of course, based on the discussion provided herein, one of ordinary skill in the art will recognize a number of other scenarios to which embodiments of the present invention can be applied.

As previously mentioned, account holder 160 can also request that an account be associated with a particular presentation instrument (block 410). Thus, the previously discussed financial product marketing can be provided directly to account holder 160, who can then act to associate an offered account with a selected presentation instrument 150. In some cases, the request identifies a presentation instrument 150 and the account that is to be associated with the presentation instrument. Upon receiving the request, the characteristics of the account to be associated are determined (block 420). Such characteristics can include account ownership, account credit limits, primary and secondary liability for the account, whether the account is a member of an account group as discussed further in the U.S. Patent Applications incorporated herein by reference, and the like. Further, similar characteristics associated with presentation instrument 150 can be determined.

Either after a request from an entity providing an account is received and approved (blocks 405, 415), or upon receiving a request from account holder 160 and determining the characteristics of the account to be associated with a presentation instrument 150 (blocks 410, 420), business rules are applied to assure that the requested association is acceptable (block 425). Thus, for example, it can be assured that the account and the presentation instrument are owned by the same account holder. As another example, it can be determined whether it is possible for liabilities incurred using the presentation instrument to be applied to the account. Many other such business rules can be applied to assure that the proposed association is proper. Where application of the business rules indicate that the association of the account with the presentation instrument is for some reason not proper (block 430), the attempted association is terminated (block 440).

Alternatively, where application of the business rules indicate that the association is acceptable (block 430), the account is associated with the presentation instrument (block 435) and the rules associated with the presentation instrument are updated to reflect the new association (block 450). Such association can include updating an account holder's record on database 220 to reflect the newly added account. Such updating of database 220 can be done in any number of ways known to those of ordinary skill in the art.

Based on the disclosure provided herein, one of ordinary skill in the art will recognize many other methods for associating one or more accounts with a presentation instrument, and/or requesting such association. For example, in some embodiments, association can be done automatically by transaction processor 120 based on certain business rules. As another example, an account holder may perform such associations by accessing database 220 and associating one or more accounts with a particular presentation instrument.

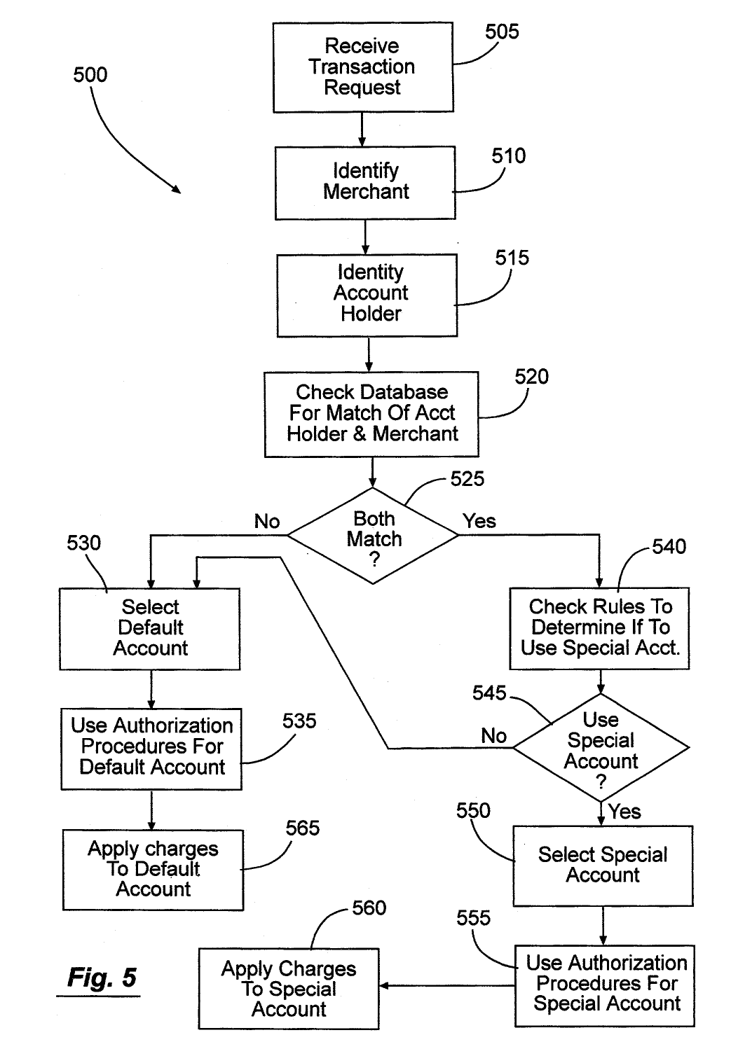

Turning now to FIG. 5, a flow diagram 500 illustrates a method for authorizing transaction requests in accordance with some embodiments of the present invention. Following flow diagram 500, a transaction request is received (block 505). In some cases, such a transaction request is received from merchant 140, and identifies presentation instrument 150, an associated transaction amount, merchant 140, and/or account holder 160. From the transaction request, the merchant is identified (block 510), and an account holder associated with the transaction request is also identified (block 515). Transaction processor 120 uses this information to query database 220 to determine if a match exists between account holder 160 and merchant 140 (blocks 520, 525). In some cases, a match occurs where presentation instrument 150 is associated with an account 130 maintained by merchant 140. In other cases a match occurs where account holder 160 is an owner of an account 130 maintained by merchant 140, but not associated with presentation instrument 150. In such a situation, account holder 160 could be asked to approve an association between the matched account and presentation instrument 150.

Where a match does not exist, a default account associated with presentation instrument 150 is selected (block 530). Thus, for example, where presentation instrument 150 is associated with a general credit card account and a checking account, but neither of the accounts provides any advantages related to merchant 140 or any particular reason to accept charges from merchant 140, then the transaction can be applied to a default of either the checking account or the general credit card account depending upon rules 155.

Rules 155 can be defined by account holder 160, transaction processor 120, entities maintaining and/or offering accounts, or a combination thereof. Modifications to rules 155 can be performed using one or more methods suggested in U.S. Patent Application entitled “Systems And Methods For Accessing And Modifying Usage Parameters Associated With a Financial Transaction Account”, that was previously incorporated herein by reference for all purposes. Upon selecting the default account, authorization procedures associated with the default account are used to approve the transaction request (block 535). Thus, for example, where rules 155 indicate that the default account is the general credit card account, authorization of the transaction request is performed as would any other transaction being applied to the general credit card account.

After the transaction is authorized in accordance with the default account, the transaction is completed, and the transaction amount is posted to the default account (block 565). In some cases, the transaction that is authorized is not the exact transaction that is posted. Thus, as an example, a transaction may be authorized for five-hundred dollars and qualify as a big ticket item. As such, the transaction may be authorized to an account that provides an advantage for transactions involving big ticket items. However, the purchaser may later use a coupon, or notify a clerk that the five-hundred dollar price does not reflect the sale price offered by the merchant. As such, the consummated transaction may be for an amount less than the previously authorized five-hundred dollar amount. This subsequent amount may not qualify for the benefits previously identified for the purchase of a big ticket item. Said another way, when the rule set is used in light of the authorized transaction, the rule set indicates that the transaction should be posted to one particular account, while the same rule set when applied to the consummated transaction would indicate that the transaction should be posted to a different account.

According to the present invention, various approaches are possible to address conflicts resulting from the occasional difference between authorized transactions and posted transactions. In one embodiment, the approach is to require that the consummated transaction be re-authorized to reflect the actual transaction. As such, no disparity between the authorized and consummated transactions would exist, and the consummated transaction would be applied to one or more of the associated accounts in compliance with the rule set. This provides complete consistency between the desired application of various liabilities, however, this imposes a cost on the merchant in terms of both money and time.

Other approaches can include posting the transaction amount to an account selected during the authorization process regardless of any difference between the authorized and posted transaction. Thus, for example, where a transaction is directed to a particular account during the authorization process, but the basis upon which the transaction was directed changes before the transaction is consummated, the transaction will still be directed to the account selected during the authorization process. Thus, in some cases, the transaction may be directed to an account that would not have been selected had the final transaction information been known at the time the transaction had been authorized. In some cases, this is not significant as the occurrence of a difference between the authorized transaction and the consummated transaction can be infrequent.

In some embodiments, these infrequent occurrences are reported to the account holder with an explanation. In other instances, these infrequent occurrences are reported to an issuer which is primarily responsible for providing customer service information to the account holder. Thus, where the account holder desires to find out why a transaction posted contrary to the rule set, they merely need to contact the customer service provider for such information, rather than contacting an entity that maintains and/or services the account to which the transaction posted.

Alternatively, in some embodiments, transactions are posted to the account to which the transaction was authorized. Where a discrepancy between the authorized transaction and the consummated transaction are identified, the rule set is re-applied to the transaction as consummated and it is determined if the transaction was posted to the proper account. In the case that the rule set indicates that another account should have been selected. An authorization is performed according to the rules of the other account, the transaction is removed from the account to which it was originally posted, and the transaction is applied to the other account. In this way, the transaction can be directed to another more suitable account without involving input from a clerk working at the merchant location, or an immediate re-authorization process as previously discussed.

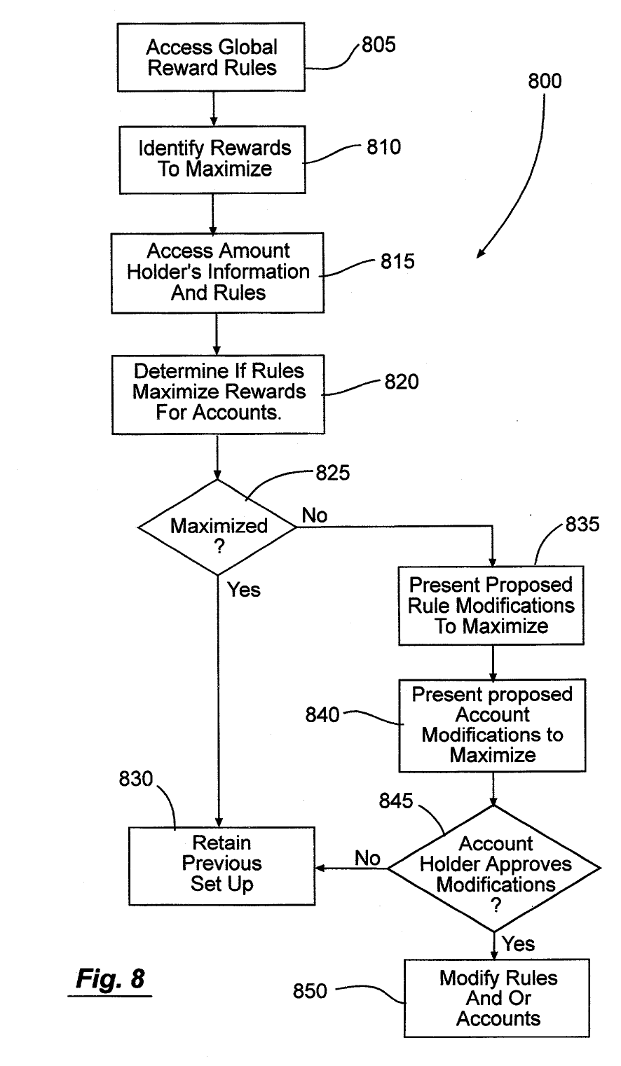

Alternatively, where a match is found (block 525), rules 155 are accessed to determine if the transaction amount is to be applied to the matching closed loop account, or to the default account (block 540). Rules 155 can include an identification of certain advantages for using a closed loop account to consummate the purchase of various goods and/or services. For example, a merchant may be running a special on particular goods that when purchased using a closed loop account, an account holder realizes an additional savings, or qualifies for some additional benefit. In such a case, rules 155 may indicate that it is more advantageous to use the closed loop account rather than a default account. It may be that the default account offers various features for using the default account, thus rules 155 may be tailored to determine which of the closed loop account and the default account is most advantageous for a particular transaction request. Rules 155 can be based on selection criteria provided by account holder 160, automatically generated by transaction processor 120, and any combination thereof. Further, rules 155 can be based on information provided from a number of merchants, credit card companies, banks, and other entities maintaining accounts. Such information makes it possible to maximize various incentive features offered by one or more account providers. Such maximization is further discussed below in relation to FIG. 8.

In some cases, rules 155 are relatively simple and dictate that any purchases from a particular merchant be applied to that merchant's account, while all other transaction amounts are applied to a default account. Other rules 155 are slightly more complex, but apply similar controls over which transaction requests are routed to the various accounts associated with the presentation instrument. For example, rules 155 may dictate that transaction requests associated with a particular type of goods are applied to one account, while transaction requests associated with another type of goods are applied to another account. Thus, for example, all purchases of travel products may be posted to one general credit card account, all purchases of home improvement products posted to a stored value account, and all other transaction requests are applied to another general credit card account. Based on the disclosure provided herein, one of ordinary skill in the art will recognize a myriad of other rule sets capable of governing the distribution of transaction requests between a plurality of accounts. Further, one of ordinary skill in the art will recognize the various parties potentially involved in defining such rule sets including account holders, merchants, transaction processors, banks, credit card companies, and the like.

After checking rules 155 (block 540), it is determined which of various closed loop accounts and/or general purpose accounts are to be used, or a default account (block 545). If for example, a closed loop account is not selected, authorization proceeds as previously discussed in relation to the default account (blocks 530, 535). Alternatively, the closed loop account is selected (block 550), and authorization procedures associated with the closed loop account are used to authorize the transaction request (block 555). Such authorization procedures can include various authorization procedures and/or protocols known in the art, as well as other procedures that one of ordinary skill in the art would recognize as being useful in accordance with the present invention.

After the transaction is authorized in accordance with the special account, the transaction is completed, and the transaction amount is posted to the special account (block 565). It should be recognized that the discrepancy processing as discussed in relation to block 565 above is applicable also to block 560.

It should be noted that flow diagram 500 illustrates one way of performing authorizations. Based on the disclosure provided herein, and in accordance with the present invention, one of ordinary skill in the art will recognize other ways of performing authorizations. For example, in some embodiments, the account holder may not be identified, but rather only a presentation instrument used in relation to the transaction request.

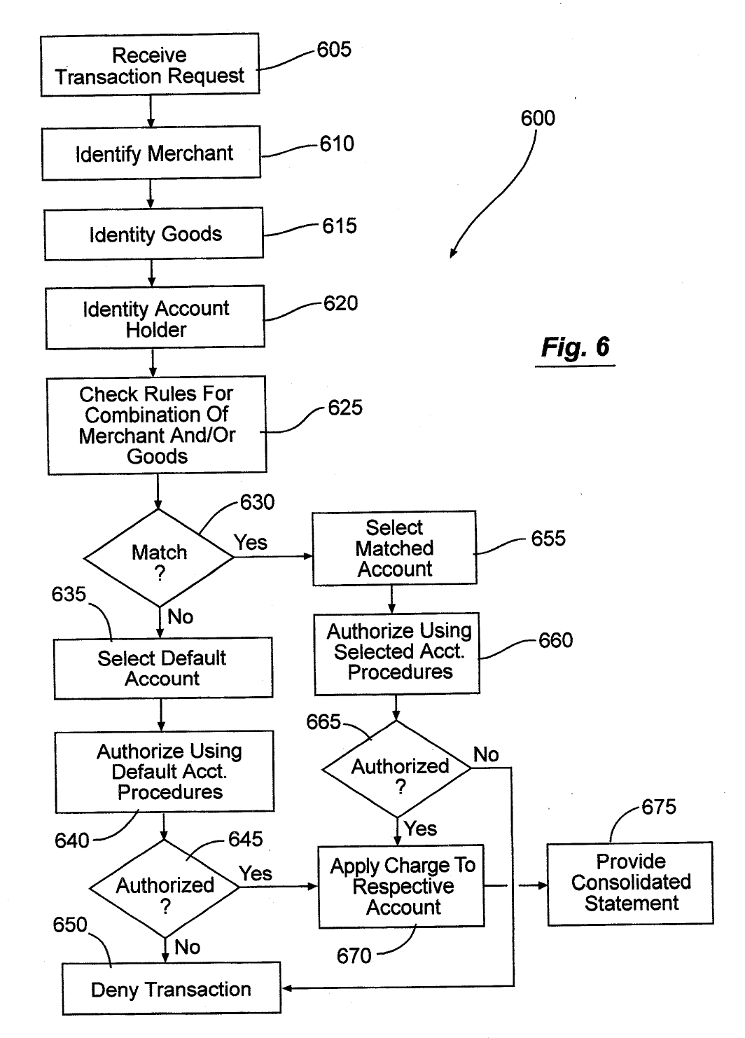

Turning now to FIG. 6, a flow diagram 600 illustrates a method for processing transaction requests in accordance with some embodiments of the present invention. Following flow diagram 600, a transaction request is received (block 605). From the transaction request, the merchant is identified (block 610), the goods that are the subject of the transaction request are identified (block 615), the transaction amount, and the account holder is identified (block 620). Further, rules 155 related to presentation instrument 150 are accessed to determine which account to apply the transaction amount (block 625).

Rules 155 are applied to the combination of goods, account holder, and/or merchant to determine if one account associated with presentation instrument 150 is to receive the transaction amount. If the rules indicate that no special use account is to be chosen in the particular instance, a default account is selected. Thus, after applying the rules (block 625), it is determined if a particular account associated with presentation instrument 150 is to receive the transaction amount (block 630). If a match to one particular account is determined (block 625), then the matching account is selected (block 655), otherwise a default account is selected (block 635).

Where the default account is selected (block 635), authorization is performed in accordance with the default account authorization procedures (block 645). If the transaction request is authorized, the transaction amount is applied to the default account (block 670). It should be recognized that the discrepancy processing as discussed in relation to blocks 560, and 565 above is applicable also to block 670. Alternatively, where the transaction request is not approved (block 645), it is denied (block 650).

In contrast, where the matched account is selected (block 655), authorization is performed in accordance with the matched account authorization procedures (block 660). If the transaction request is authorized (block 665), the transaction amount is applied to the matched account (block 670). Alternatively, where the transaction request is not approved (block 665), it is denied (block 650).

In some cases, a consolidated statement of all activity associated with presentation instrument 150 is provided (block 675). Such a consolidated statement can include all transactions processed in relation to presentation instrument 150, with an indication of which accounts 130 that the various transaction amounts were applied. Further, the consolidated statement can include an indication of which rule within rule set 155 triggered application of a particular transaction to a given account, and any exceptions that were generated due to discrepancies between the transaction as authorized and the transaction as consummated. Yet further, the consolidated statement can include an indication of all features received during a period, and a breakdown of the transactions from which the awards were derived. Each of the accounts associated with presentation instrument 150 can settle separately, however, transaction processor 120 may also offer a service of accepting one single payment and disbursing it between the various accounts. Such a process is disclosed in U.S. Patent Application entitled “Methods For Processing a Group of Accounts Corresponding to Different Products”, that was previously incorporated herein by reference for all purposes. Such processes can be adjusted to apply the payment to bring all accounts current, to bring delinquent accounts current initially, and/or to apply pro-rata shares of the payment across the various accounts. In some instances, the individual accounts are reported separately. For example, where account specific profitability, product roll-up, and/or performance information is desired, the accounts can be reported individually.

Again, it should be noted that flow diagram 600 provides one way of processing transactions. Based on the disclosure provided herein, and in accordance with the present invention, one of ordinary skill in the art will recognize other ways of performing such processing. For example, in some embodiments, the type of goods may not be identified and the rules applied to determine an underlying account to which to apply the transaction amount may not include any analysis of the goods subject to the transaction request.

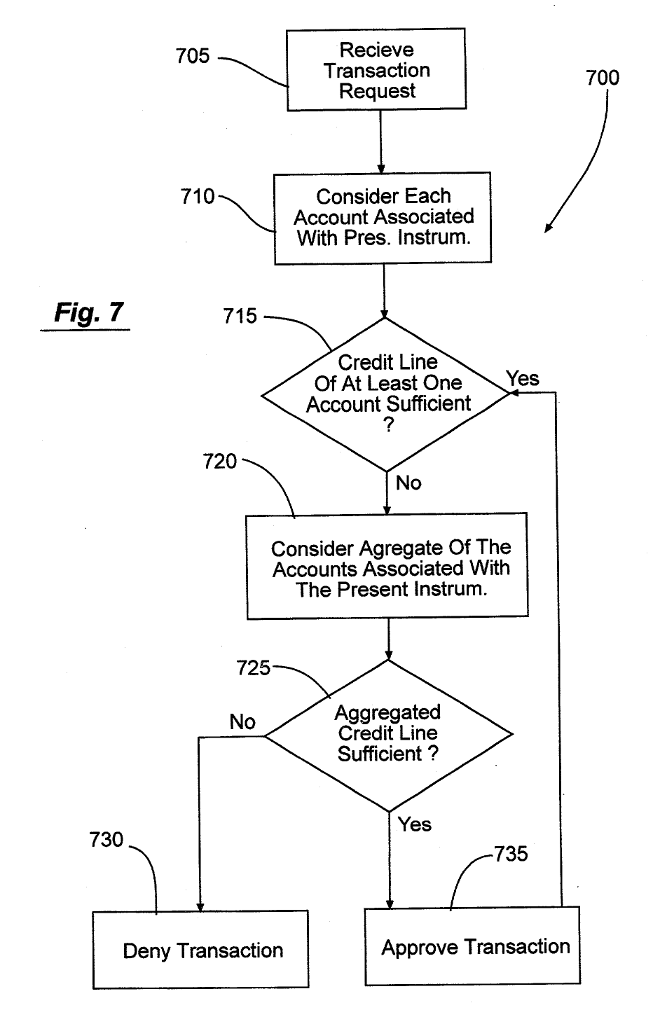

Turning to FIG. 7, a flow diagram 700 illustrates another method for authorizing transaction requests such that the transaction is split between various accounts. Following flow diagram 700, a transaction request is received (block 705). Each account associated with presentation instrument 150 is considered to determine which account would be the best fit to receive the transaction (block 710). Based on the transaction goods, transaction amount, and/or other specifics of each account associated with presentation instrument 150, the appropriate account can be selected. Thus, for example, where the type of goods conform to that purchasable using a particular account, and the transaction amount is less than the available credit limit of that account, then that account is a candidate to receive the transaction. In some cases, more than one account is a candidate. In such cases, rules 155 can be used to choose between the various candidate accounts. Based on the disclosure provided herein, one of ordinary skill in the art will recognize other mechanisms, and/or information that can be use to determine an account capable of accepting the transaction request.

The remaining portions of flow diagram 700 illustrate an example where the credit line of the various accounts is used to determine which account(s) to apply the transaction. It is determined if at least one of the accounts associated with presentation instrument 150 has a credit line sufficiently large to receive the transaction request (block 715). Where an account is found that can satisfy the transaction request (block 715), that account is selected, authorized in accordance with procedures related to that account, and the transaction request is approved (block 735).

Alternatively, where no single account associated with presentation instrument 150 can satisfy the transaction request (block 715), an aggregate of the accounts is considered (block 720). Thus, the credit line of two or more accounts associated with presentation instrument are combined, and the combined credit limit is compared to the transaction amount. Where the combined credit limit is sufficient to cover the transaction amount (block 725), the transaction request is divided into portions that satisfy the credit limits of each of the accounts involved in the aggregation, the portions of the transaction request are authorized in accordance with procedures related to the accounts to which the various portions will be applied, and the transaction request is approved (block 735). Alternatively, the transaction request is denied (block 730). In some cases, the transaction request can be portioned simply by a cost division, or some other way. For example, the transaction request may be portioned according to the goods being purchased, where one type of goods is portioned to one account and another type of goods to another account. Based on the disclosure provided herein, one of ordinary skill in the art will recognize other types of portioning applicable to dividing transaction requests, and various mechanisms for facilitating such portioning.

Thus, while presentation instrument 150 may not be associated with an individual account that can service a particular transaction request, two or more accounts may be accessed in accordance with the present invention to service a given transaction request. Thus, the present invention provides yet another mechanism for coalescing the functionality of a variety of accounts, while allowing the underlying accounts to settle separately and/or authorize separately where such is desired.

It should be recognized that such splitting of a transaction request can also be done to obtain the highest possible rewards. Thus, for example, where a general credit account gives significant rewards, but the remaining credit limit is less than that required to cover the transaction amount, a portion of the transaction amount corresponding to the credit account limit can be applied to the credit account, and the other portion applied to one or more other accounts. Alternatively, where use of one account exhibits desireable features for transactions involving certain goods, the portion of the transaction request reflecting such goods can be applied to the account, with the other portion of the transaction request being applied to another account(s).

One particular application of the present invention involves extending promotional credit lines directed at stimulating various consumer behavior. For example, the present invention can include the ability to identify a promotional purchase at the point of an authorization, and expand the credit line associated with a closed loop account to meet a purchase need. Further, methods of the present invention can further manage the credit line so that the credit expansion is only applicable to the particular purchase. As the purchase is paid off the expanded available credit is not retained.

Other variations can exist for extending additional credit for non-promotional activity.

For example, where promotion of a large item is outside the credit limit on a closed loop account, the credit limit of the closed loop account can be utilized to satisfy a portion of the purchase amount, and a second closed loop account could be created to accept the unfulfilled purchase amount. When the second closed loop account is paid off, the second account is terminated and disassociated from the presentation instrument. In addition, rules 155 associated with the presentation instrument could be modified to indicate that the second account cannot be used for any other purpose. Further, rules 155 could be modified to limit activity on the first closed loop account, until the second closed loop account is paid off.

Turning to FIG. 8, a flow diagram 800 illustrates a method for pooling and/or maximizing features obtained through use of one or more accounts associated with a presentation instrument. Following flow diagram 800, a database of global feature rules is accessed (block 805). Such rules can include identification of features provided in relation to given account types, the criteria for providing such features, and whether such features can be pooled with other features obtained from accounts that are members of a group, and the like. The various feature and pooling rules can be accessed from one or more issuers, or other similar sources. Further, it is determined which features to maximize (block 810). In some cases, this is determined by identifying the accounts associated with a given presentation instrument, and identifying the types of features provided via such accounts. In other instances, the features to be maximized are provided by an account holder to a transaction processor. In this way, an account holder can identify the features which are of particular interest to the account holder.

It is determined if rules 155 then associated with a presentation instrument actually maximize features available through use of the various accounts (block 820). This can be accomplished by applying rules 155 to one or more spending models to determine if the features are maximized. Of course, other mathematical approaches for maximizing returns can be utilized in accordance with the present invention. If the features are maximized (block 830), rules 155 are retained (block 830).

If rules 155 do not maximize the available feature(s), then a modification to rules 155 is determined that will maximize the feature(s), and the modification is presented to the account holder (block 835). This can be done across the Internet, or via the telephone, email, mail, or the like. Further, in some cases, an account holder is presented with additional financial product accounts that may be associated with presentation instrument 150 to further maximize the desired features (block 840). Thus, feature maximization can provide additional avenues to market financial products to account holders. An account holder is asked to approve the proposed modifications to rules 150 and/or to add an additional account (block 845). Alternatively, the account holder could be asked to propose a change in addition to, or in place of the proposed modification. If the account holder accepts (block 845), rules 155 and/or the accounts associated with presentation instrument 150 can be modified (block 850) accordingly, otherwise rules 155 are retained in their unmodified form (block 830).

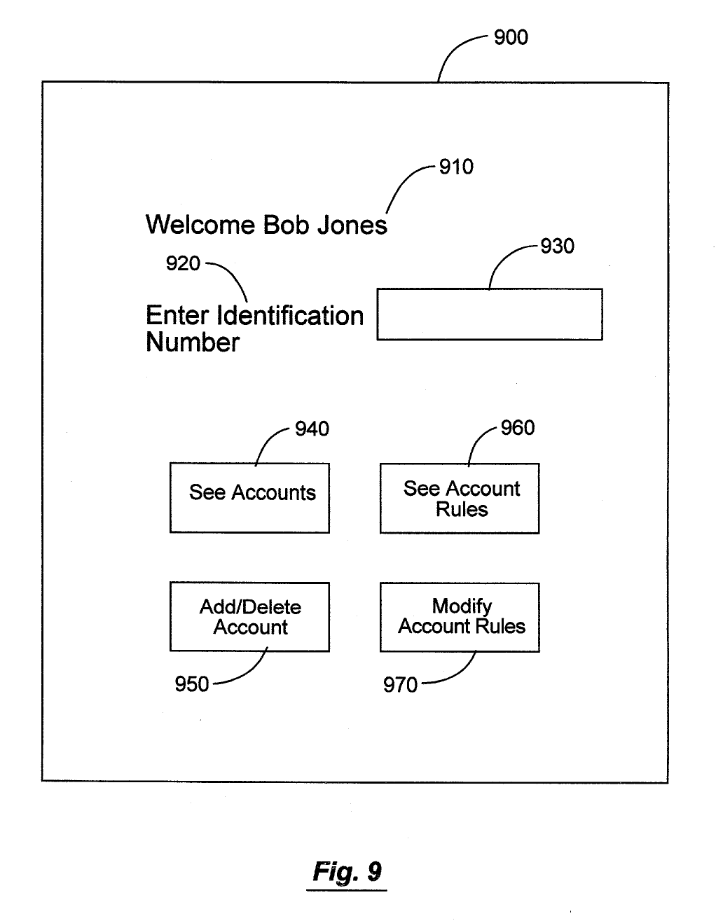

Referring to FIG. 9, an exemplary embodiment of a website 900 offering access to account holder information is illustrated. Website 900 includes a welcome message 910 to an account holder. In some cases, welcome message 910 is derived from a login website displayed prior to website 900. On such a login website, the account holder can enter their name and a password which, when authenticated and/or authorized, leads the account holder to website 900. Based on this disclosure, one of ordinary skill in the art will recognize other authentication methodologies that can be used in relation to the present invention.

On website 900, an entry box 930 associated with a direction field 920 is provided to accept an identification number associated with a presentation instrument of interest. For example, in some cases, a credit card number can be entered. After the identification number is entered, one of a variety of selection buttons 940, 950, 960, 970 are pressed. Pressing such selection buttons then lead the user to another website. Such selection buttons can include, but are not limited to, a see accounts selection button 940 that leads a user to a display of all accounts associated with the entered identification number. Another selection button can be an add/delete button 950 that leads a user to a website that displays all accounts associated with the entered identification number and allows a user to add an additional account and/or disassociate an existing account. Another example can be a see account rules button 960 that leads a user to a website that displays the rule set associating the various accounts to the identification number. Yet another example is a modify account rules button 970 that leads a user to a website that displays the rule sets, and allow the user to modify the rule set. On such a page, various rule options could be provided. As just one example, the rule options associated with the feature maximization discussed in relation to FIG. 8 could be provided on such a page.

The invention has now been described in detail for purposes of clarity and understanding. However, it will be appreciated that certain changes and modifications may be practiced within the scope of the appended claims. Accordingly, it should be recognized that many other systems, functions, methods, and combinations thereof are possible in accordance with the present invention. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. A method for processing transactions realized using presentation instruments, the method comprising:
identifying a presentation instrument associated with a transaction request, wherein the transaction request includes a transaction amount, and wherein the presentation instrument is associated with at least a first account and a second account; and
determining a portion of the transaction amount to apply to the first account.

2. The method of claim 1, wherein the first account is a closed loop account, the method further comprising:
identifying a merchant associated with the transaction request, wherein the merchant is selected from a group consisitng of: a merchant associated with an issuer of the closed loop account, and a merchant issuer of the closed loop account; and
identifying a match of the first account and the merchant, wherein the determining a portion of the transaction amount to apply to the first account is based at least in part on the identified match.

3. The method of claim 1, wherein the first account is a closed loop account, the method further comprising:
identifying a merchant associated with the transaction request, wherein the merchant is selected from a group consisitng of: a merchant associated with an issuer of the closed loop account, and a merchant issuer of the closed loop account;
identifying a match of the first account and the merchant;
approving the transaction request, wherein approving the transaction request is done in accordance with authorization procedures associated with the closed loop account; and
wherein the determining a portion of the transaction amount to apply to the first account is based at least in part on the identified match.

4. The method of claim 1, wherein the first account is a general account and the second account is a closed loop account, the method further comprising:
identifying a merchant associated with the transaction request; and
accessing a database including information associated with a holder of the presentation instrument, wherein the information associated with the holder does not indicate that the presentation instrument is associated with the merchant; and
wherein the determining a portion of the transaction amount to apply to the first account is based at least in part on the information associated with the holder.

5. The method of claim 4, the method further comprising:
approving the transaction request, wherein approving the transaction request is done in accordance with authorization procedures associated with the general account.

6. The method of claim 1, wherein the first account is a closed loop account, the method further comprising:
identifying a merchant associated with the transaction request, wherein the merchant is selected from a group consisitng of: a merchant associated with an issuer of the closed loop account, and a merchant issuer of the closed loop account;
identifying a good associated with the transaction request;
identifying a match of the first account and the merchant; and
wherein the determining a portion of the transaction amount to apply to the first account is based at least in part on the identified match, and the identified good.

7. The method of claim 1, wherein the portion of the transaction amount includes all of the transaction amount.

8. The method of claim 1, wherein the portion of the transaction amount is a first portion, the method further comprising:
determining a second portion of the transaction amount to apply to the second account, wherein the first portion and the second portion are both non-zero amounts.

9. The method of claim 1, the method further comprising:
associating the first account with the presentation instrument;
associating the second account with the presentation instrument;
providing a consolidated statement reflecting at least a portion of the transactions associated with the first account and the second account.

10. The method of claim 1, the method further comprising:
accessing a rule set associated with the presentation instrument, wherein the determining a portion of the transaction amount to apply to the first account is based at least in part on the rule set.

11. The method of claim 10, wherein the rule set is defined to maximize one or more features associated with one or more of the first account and the second account.

12. The method of claim 11, wherein the rule set is at least partially defined by a holder of the presentation instrument.

13. The method of claim 11, the method further comprising:
defining the rule set;
providing the rule set to a holder of the presentation instrument; and
receiving authorization to apply the rule set.

14. The method of claim 1, the method further comprising:
approving the transaction request, wherein approving the transaction request is based in part on a first credit limit associated with the first account and a second credit limit associated with the second account.

15. The method of claim 1, wherein the first account is a special purpose general account, the method further comprising:
identifying a characteristic associated with the transaction request, wherein the characteristic is related to the special purpose general account;
identifying a match of the characteristic and the special purpose general account;
approving the transaction request, wherein approving the transaction request is done in accordance with authorization procedures associated with the special purpose general account; and
wherein the determining a portion of the transaction amount to apply to the first account is based at least in part on the identified match.

16. The method of claim 15, wherein the characteristic is a class of goods.

17. The method of claim 15, wherein the characteristic is a transaction amount.

18. The method of claim 15, wherein the characteristic is a merchant.

19. The method of claim 1, wherein the first account is a home equity line, the method further comprising:
identifying a class of goods associated with the transaction, wherein the class of goods includes home improvement products chargeable to the home equity line;
identifying a match of the class of goods and the home equity line; and
wherein the determining a portion of the transaction amount to apply to the first account is based at least in part on the identified match.

20. A system for processing transactions realized using presentation instruments, the system comprising:
a computer including a processor, a communication device, and a computer readable medium, wherein the communication device is operable to receive a transaction request including a transaction amount, and wherein the computer readable medium includes information about a presentation instrument associated with at least a first account and a second account, and instructions executable by the processor to:
identify the presentation instrument associated with the transaction request; and
determine a portion of the transaction amount to apply to the first account.

21. The system of claim 20, wherein the instructions are further executable by the processor to:
identify a merchant associated with the transaction request, wherein the merchant is an issuer of the closed loop account; and
match the first account and the merchant, wherein the determining a portion of the transaction amount to apply to the first account is based at least in part on the match.

22. The system of claim 21, wherein the instructions are further executable by the processor to:
approve the transaction request in accordance with authorization procedures associated with the first account.

23. The system of claim 21, wherein the computer readable medium further comprises a rule set, and wherein the instructions are further executable by the processor to:
apply the rule set to the transaction request, wherein determining the portion of the transaction amount to apply to the first account is further based at least in part on application of the rule set.

24. The system of claim 20, wherein the computer readable medium further comprises a rule set, and wherein the instructions are further executable by the processor to:
identify a good associated with the transaction request; and
apply the rule set to the transaction request, wherein the determining a portion of the transaction amount to apply to the first account is based at least in part on the good.

25. A method for consummating transactions realized using presentation instruments, the method comprising:
associating a closed loop account with a presentation instrument, wherein the presentation instrument is associated with a general account;
receiving the presentation instrument in relation to a transaction request, wherein the transaction request includes a transaction amount; and
applying the transaction amount to the closed loop account.

26. A system for linking a plurality of presentation instruments to a plurality of accounts, the system comprising:
a computer readable medium, wherein the computer readable medium includes a first record associating a first presentation instrument with a first and a second account, and a second presentation instrument with a third and a fourth account.

27. The system of claim 26, wherein the first account is a default account to the first presentation instrument, and the third account is a default account to the second presentation instrument.

28. The system of claim 27, wherein the second account and the fourth account are the same account.

29. A method for processing transactions realized using a presentation instrument, the method comprising:
identifying a presentation instrument associated with a transaction request, wherein the transaction request includes a transaction amount, and wherein the presentation instrument is associated with at least a first account and a second account; and
selecting the first account to receive the transaction request;
receiving authorization to apply the transaction request to the first account; and
selecting one of the first account and the second account to post the transaction request.

30. The method of claim 29, wherein the transaction request as authorized is different from the transaction request as posted.

31. The method of claim 30, the method further comprising:
selecting the second account to receive the transaction request as posted;
re-authorizing the transaction request for application to the second account, wherein the transaction request as re-authorized is the same as the transaction request as posted; and
wherein selecting one of the first account and the second account to post the transaction request includes selecting the second account.

32. The method of claim 29, wherein selecting one of the first account and the second account to post the transaction request includes selecting the first account, the method further comprising:
generating an exception report indicating the difference between the transaction as authorized and the transaction as posted.

33. The method of claim 29, wherein selecting one of the first account and the second account to post the transaction request includes selecting the first account, the method further comprising:
selecting the second account to receive the transaction request as posted;
re-authorizing the transaction request for application to the second account, wherein the transaction request as re-authorized is the same as the transaction request as posted; and
transferring the transaction request as posted from the first account to the second account.

34. The method of claim 33, the method further comprising:
generating an exception report indicating a reason for transferring the transaction request as posted from the first account to the second account.
